(19) United States
(12) Patent Application Publication
(10) Pub. No.: US 2007/0115257 A1
(43) Pub. Date: May 24, 2007

(54) Sequence status display during output for signal generator

(76) Inventors: Toshio Sugiyama, Shizuoka (JP); Toru Takai, Tokyo (JP)

Correspondence Address: WILLIAM K. BUCHER, TEKTRONIX, INC., P O BOX 500 (50-LAW), BEAVERTON, OR, 97077-0001, US

(21) Appl. No.: 11/601,048

(22) Filed: Nov. 17, 2006

(30) Foreign Application Priority Data
Nov. 24, 2005 (JP) 2005-339284

(51) Int. Cl. G09G 5/00

(52) U.S. Cl. 345/156

(57) ABSTRACT

A signal generator displays signal patterns according to a sequence and displays a current output or waiting signal pattern distinctively from other signal patterns after the start of signal output operation. Identifiers such as index numbers may be related to the respective signal patterns and displayed. The identifier of the current output or waiting signal pattern is blinked to distinguish the signal pattern from other signal patterns. Alternately, the color of the current output or waiting signal pattern may be reversed or highlighted to easily identify the signal pattern from the other signal patterns.

### BACKGROUND OF THE INVENTION

The present invention relates generally to signal generator displays and more particularly to a signal generator display that allows a user to easily confirm a waveform output sequence status even after the initiation of the signal generation.

To check the operation of an electrical circuit under test, a test signal is provided to the circuit under test. A signal generator is an apparatus that provides such a test signal for checking the operation of the circuit under test. The signal generator has controls for setting-up the test signal according to user settings. The output signal from the electrical circuit may be observed by a measurement instrument, such as an oscilloscope or the like.

FIG. 1 is a block diagram of an example of a signal generator. The signal generator is controlled by a CPU 10 according to programs stored on a storage device 22, such as a hard disk drive (HDD). A memory 12 is used for a work area for the CPU 10 to read programs from the storage device 22. A user sets up the signal generator through operation devices 20 including keys, knob, etc. A display device 18 provides information on signal patterns, user settings and the like. A waveform generation circuit 14 generates signals of user desired patterns which will be described in greater detail below. FIG. 1 shows an example of a two-channel waveform generator that has trigger and event signal inputs. The receipt of the trigger and event signals leads to conditional operations to be described below. An input/output port 24, such as a Universal Serial Bus (USB) port, is used for coupling a pointing device, such as a mouse 26 or the like, and for providing data exchange with a PC. These blocks are coupled via a bus 16.

The signal generator outputs a plurality of waveform signal patterns with the corresponding waveform data being previously stored in the HDD storage device 22 or other memory storage devices, such as a thumb drive. A user may also create additional waveform data using a personal computer and waveform editor software and transfer the waveform data to the signal generator using the input-output port 24. The waveform editor software provides various edit tools, such as the application of a desired function, drawing of waveform using a mouse, and the like. Waveform data acquired by an oscilloscope from an actual circuit may also be used to generate waveform data for the signal generator.

FIG. 2 is a block diagram of an example of the waveform generation circuit 14. The block diagram of the first channel is shown in detail since the first and second channels are substantially the same. A sequencer 34 has address counters (not shown) to access sequence memory 30 and waveform memory 32. Sequence instructions of signal patterns defined by user settings are stored in the sequence memory 30 via the sequencer 34. The instructions have operation and address parts. The operation parts designate data processes and have descriptions of codes corresponding to sequence control parameters such as loop, conditional jump, etc. The address parts have descriptions concerning, for example, the initial address and how many addresses should be read (length of the address). The sequencer 34 provides addresses to the waveform memory 32 to read stored waveform data according to the sequence instructions from the sequence memory 30. The waveform data is provided to a parallel to serial converter 36. The parallel to serial converter 36 compensates for slow data read speed from the memory and accelerates the data transfer speed though the number of data bits decrease. A digital to analog converter 39 converts the output data of the parallel to serial converter 36 into an analog signal. A control and bus interface circuit 40 controls the channels and data exchange with the bus 16.

FIG. 3 is an example of a table of an output sequence on the display device 18 for channel 1 (CH1) and channel 2 (CH2) waveform signal patterns. The sequence is designated by indexes that are labeled as 1, 2, 3 . . . n or the like The user assigns a desired signal pattern to each index for-each channel with a signal pattern name. The signal generator outputs the signal patterns according to the order of the indexes and terminates the signal output when the signal pattern of the last index is over. A slider 52 on a scroll bar 50 is provided and moved up or down by a mouse, keyboard control or the like. A desired portion of the sequences in the table can be selectively displayed by moving the slider 52 to a selected index. The display of FIG. 3 may be a window on the display 18.

The table of FIG. 3 allows the user to set up the signal generator to provide a more complex output signals using sequence control parameters, such as “Trigger Wait”, “Loop”, conditional “Event Jump”, “Go To”, and the like. Index 3 shows “Trigger Wait” is “ON”. The signal patterns of indexes 1 and 2 are provided as outputs and then the signal generator suspends the outputs. If a trigger signal that satisfies user settings is provided to the trigger input terminal, the signal generator resumes the outputs from the signal patterns designated by the index 3. Index 5 shows a “loop” 100 and a conditional “Event Jump” set to 15. The sequence jumps to index 15 if the sequence reaches index 5 and an event signal satisfying user settings is provided to the event input terminal during the 100 repeats of the signal patterns designated by index 5. Alternatively, if the event signal is not provided during the 100 repeats of the signal patterns of index 5, the sequence proceeds to index 6. Index 6 is designated to advance to index 20 by an unconditional jump, or “Go To” so that when the outputs of the signal patterns designated by index 6 has finished, the sequence jumps to the index 20.

The index numbers basically correspond to the address order of the sequence memory 30 except that the first index is 1 while the initial address is zero. That is, the sequence memory addresses of 0, 1, 2, . . . n correspond to index numbers 1, 2, 3, . . . n+1 respectively. The address of the waveform memory 32 at which waveform data assigned to the index number 1 exists is described in the address part of the instruction stored at the address 0 of the sequence memory 30, and the operation part may have descriptions of sequence control parameters such as loop, etc. A reason of the index starting from 1 is for the user to realize it more easily.

In addition to the table style display shown in FIG. 3, waveform display of signal patterns to set the sequence is also used. For example, U.S. Pat. No. 5,3713,15 discloses an invention that displays waveforms acquired by sampling sound to combine them.

During the editing of signal patterns before initiating the output of the patterns, a conventional signal generator displays waveforms of the signal patterns and a user can confirm the edited patterns. But after the initiation of the output operation of the signal patterns, the signal generator displays only sequence names and the user cannot easily confirm which signal pattern is being output or waiting. Therefore, what is needed is a sequence status display for easily confirming the signal patterns currently being output and those signal patterns waiting to be output.

### SUMMARY OF THE INVENTION

The present invention relates to a display for a signal generator that generates signal patterns according to a sequence. A signal generator according to the present invention displays the signal patterns according to the sequence and, after the start of signal output operation, displays the current output or waiting signal pattern. The current or waiting signal pattern can be distinguished from other signal patterns by a displayed identifier such as an index number related to each signal pattern. The identifier of the current output or waiting signal pattern may be blinked to distinguish the signal pattern from other signal patterns. Another way of distinguishing the current output or waiting signal pattern from other signal patterns is by reversing or highlighting the color of the current output or waiting signal pattern. A similar operation may be done by using a name of the output or waiting signal pattern instead of the signal pattern. These functions may be realized by providing a means for reading a current address of a sequence memory in the signal generator.

The present invention provides a signal generator user interface that can provide information on the sequence status even after the start of the signal output operation. According to the present invention, the display that is used for displaying and editing signal patterns before the start of the signal output operation is modified for use after the start of the signal output operation to provide the sequence status information, which provides the user with user-friendly operation.

The objects, advantages and other novel features of the present invention are apparent from the following detailed description when read in conjunction with the appended claims and attached drawings.

### BRIEF DESCRIPTION OF THE DRAWINGS

FIG. 1 is a block diagram of a signal generator.

FIG. 2 is a block diagram of a conventional waveform generation circuit.

FIG. 3 is a display example of an output sequence as a table style.

FIG. 4 is a block diagram of a waveform generation circuit suitable for the present invention.

FIG. 5 is an example of a sequence display according to the present invention.

FIG. 6 is a flow chart of a display method according to the present invention.

### DETAILED DESCRIPTION OF THE INVENTION

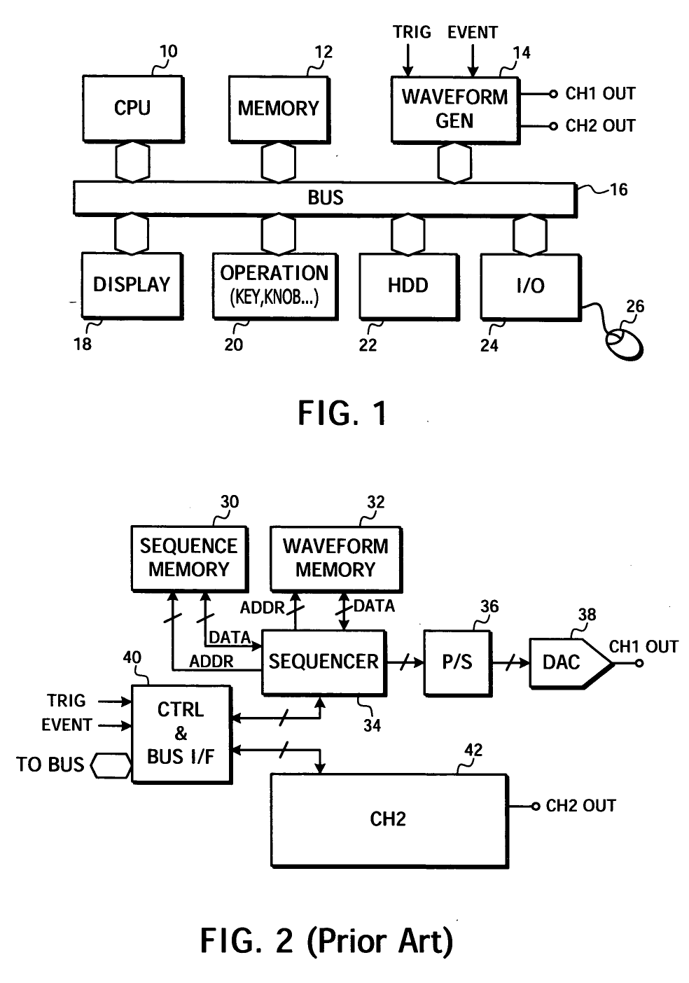

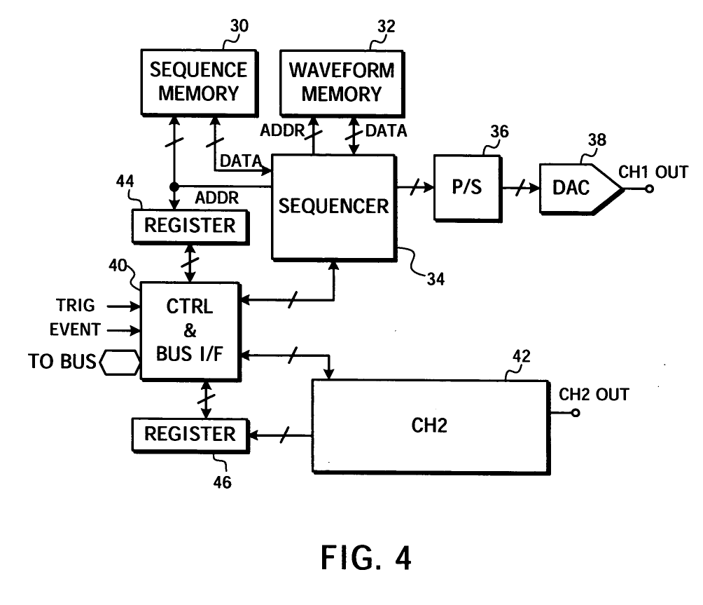

A signal generator implementing the present invention is basically the same as that of FIG. 1 but with a modified waveform generation circuit. FIG. 4 is a block diagram of a waveform generation circuit suitable for the present invention. In the following descriptions, similar elements from previous drawing figures are labeled the same. Compared with FIG. 2, a register 44 is provided to hold a current designated address of a first channel sequence memory. The register 44 receives the current address from address counters (not shown) in the sequencer 34. When the control and bus interface 40 sends read signals to the register 44, the register 44 returns the holding address to the control and bus interface 40. The CPU 10 obtains the current address of the sequence memory 34 via the bus 16. The CPU 10 reflects the obtained information on the display as described below. As described, the addresses of the sequence memory 30 correspond to the index numbers so that if a current address is known the corresponding current index is known. The second channel 42 has basically the same hardware as the first channel and has a register 46 that corresponds to the register 44 of the first channel. The control and bus interface 40 accesses one of the registers of the channels and reads out the address data that the accessed register holds.

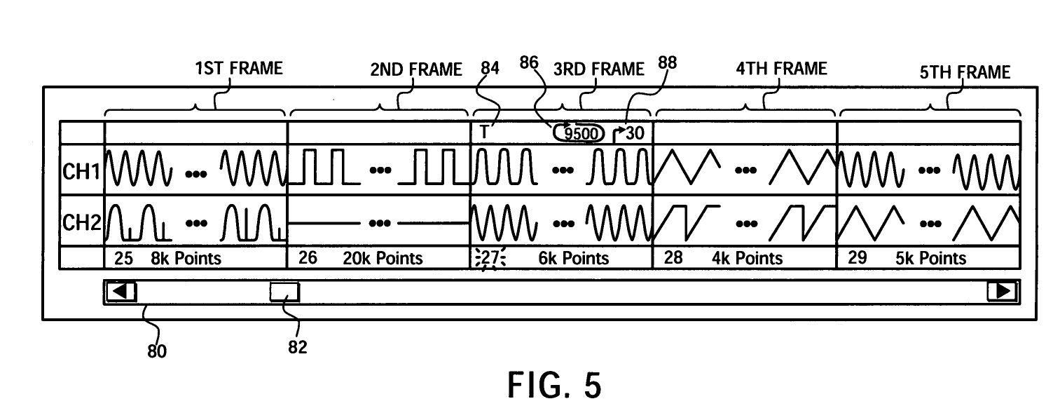

FIG. 5 is an example of a sequence display according to the present invention showing first to fifth frames of the output sequence on the display device 18. The sequence display may be displayed in one of a plurality of display window on the display device 18. Each frame of the output sequence shows the waveforms of each of the channel signal patterns. Each frame has signal patterns with the middle part of each signal pattern represented by three dots. The use of the three dots reduces the total image length of the output sequence and allows a user to effectively confirm the output sequence without having to view the total output sequence image. A scroll bar 80 having a slider 82 is displayed with the slider 82 being movable along the length of the scroll bar 80 by the use of a mouse, operation devices 20 and the like. The use of the scroll bar 80 and slider 82 allows a user to selectively display a desired frame of the output sequence. If it is necessary to confirm details of a signal pattern, the user may select and double-click on the signal pattern of the frame using the mouse before the initiation of the signal output start operation and another widow is opened to display a detailed waveform of the signal pattern. The user may then edit the detailed waveform.

The top line of the frames is used for displaying sequence control icons. The bottom line is for displaying signal pattern information that shows index numbers of the corresponding signal patterns and waveform data lengths. Referring to the third frame, a sequence control icon 84 having a character “T” indicates that a signal pattern of index 27 has a trigger waiting setting. A sequence control icon 86 having an arrow surrounding a number, such as “9500”, indicates a loop setting of 9500 repetitions of index “27”. A sequence control icon 88 having a dogleg arrow and a number “30” indicates that index 27 has an unconditional jump setting (Go To) to index 30 after the completion of index 27. The display of these sequence control icons visually tells the user that the output sequence advances to the index 27 and stops until a trigger signal arrives. If the trigger signal arrives, the signal pattern of the index 27 is repetitively provided 9500 times and then the output sequence advances to the index 30.

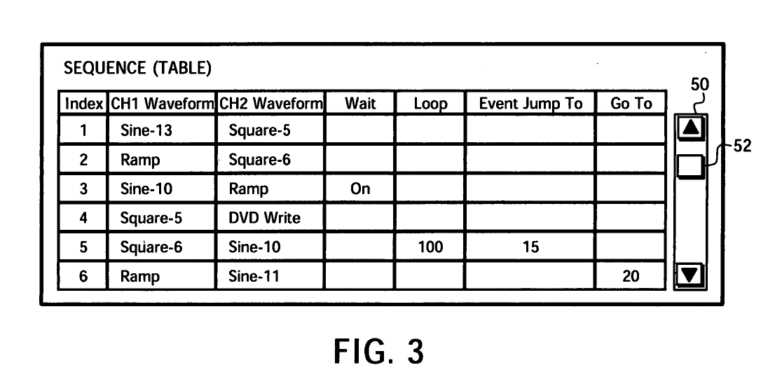

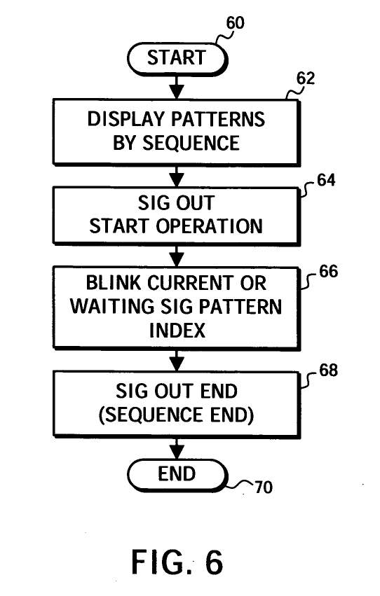

FIG. 6 is a flowchart of the display method according to the present invention. The user sets a sequence of output signal patterns in advance using a form of the table shown in FIG. 3, the waveforms shown in FIG. 5, or the like. The user may display the sequence of the signal patterns to be output in the form of the table of FIG. 3 or the waveform display of FIG. 5 on the display 18 (step 62) to visually confirm whether there are errors in the sequence. The user initiates the operation for generating the signal outputs by using the operation devices 20 (step 64). The signal generator outputs the signal patterns in the order of the index numbers (absent sequence control parameters) starting from the signal patterns of the index 1.

When the signal output operation is initiated, the CPU 10 causes the index number of the current output or waiting signal patterns on the display 18 to blink using the current address of the sequence memory 30 from the register 44. This allows the user to distinguish the current output or waiting signal patterns from other signal patterns. The waiting signal patterns are the signal patterns of the index that have a sequence control parameter of “Trigger Waiting”.

A signal output for one index generally lasts for some micro-seconds so that a user cannot visually recognize which index number is blinking on the display in many cases. However, an index that has a sequence control parameter of “Trigger Waiting” may sometimes have a duration that allows a user to recognize the blinking of the index number (“27” in this example of FIG. 5), which allows the user to check whether the sequence setting is right. Combinations of an endless loop and conditional jump (Event Jump To) repeats a signal pattern of the index until the set event signal arrives allowing a user to recognize the index number blinking to confirm the sequence status. When the sequence comes to the last index, the signal output ends (step 68).

The waveform display shown in FIG. 5 has the following display modes while the current index is changing continuously after the signal output start operation. One mode displays the current index continuously within the display screen. That is, it follows the signal pattern of the current output or waiting index and displays it at the center of the screen. Another mode does not follow the current index but remains at an index set by the user prior to the start of the sequence output. This mode is effective if there is an interesting index, and the interesting index and the neighbor ones remain in the display screen to confirm the sequence status of only the interesting index.

The example of FIG. 5 identifies the current output or waiting signal pattern by blinking the index number corresponding to the current address of the sequence memory 30 but the other method is available. For example, a frame of the current output or waiting signal pattern may be indicated by a different color than the other frames. Alternately, the signal pattern is displayed by a different color than the other signal patterns by reversing or highlighting the color of the signal pattern in order to distinguish the pattern from the other signal patterns.

As described above, the present invention allows a user to visually confirm the output sequence status even after the start of the signal output operation so that even if the user made a signal generator output signal based on improper sequence settings the user would notice the error earlier. The present invention improves the user interface and usability of the signal generator.

Although the invention has been disclosed in terms of the preferred and alternative embodiments disclosed herein, those skilled in the art will appreciate that modifications and improvements may be made without departing from the scope of the invention.

What is claimed is:

1. A display method for a signal generator generating signal patterns according to a sequence comprising the steps of:
displaying the signal patterns according to the sequence; and
displaying the current output or waiting signal pattern distinctively from the other signal patterns after the start of the signal output operation.

2. The display method recited in claim 1 wherein the step of displaying the current output or waiting signal pattern further comprises the step of displaying the current or waiting signal pattern using a color that is distinct from the other signal patterns.

3. The display method as recited in claim 1 further comprising the steps of displaying identifiers related to each of the respective signal patterns and displaying the current or waiting signal pattern identifier distinctively from the other signal pattern identifiers.

4. The display method as recited in claim 3 further comprising the step of blinking the identifier of the current output or waiting signal pattern to distinguish it from the other signal pattern identifiers.

5. The display method as recited in claim 3 wherein each of the identifiers is an index number that corresponds to a current address of a sequence memory of the signal generator.

6. The display method as recited in claim 3 further comprising the step of displaying signal pattern names related to each of the respective signal patterns and displaying the current output or waiting signal pattern name distinctively from the other signal pattern names

7. The display method as recited in claim 1 further comprising the step of continuously displaying the current output or waiting signal pattern within a display screen even if the current output or waiting signal pattern is changing.

8. A signal generator generating signal patterns according to a sequence comprising:
means for storing signal pattern data;
a sequencer for providing sets of the signal pattern data;
a sequence memory for controlling the order of the signal pattern data sets according to the sequence;
means for storing a current address of the sequence memory; and
means for displaying a current or waiting signal pattern distinctively from the other signal patterns using the current address.

9. The signal generator recited in claim 8 wherein the display means displays the current or waiting signal pattern distinctively from those of the other signal patterns using color.

10. The signal generator recited in claim 8 wherein the display means displays identifiers for each of the respective signal patterns and distinctly displays the identifier of the current or waiting signal pattern from the other signal pattern identifiers.

11. The signal generator as recited in claim 10 wherein the display means blinks the identifier of the current output or waiting signal pattern to distinguish the current output or waiting signal pattern from the other signal pattern identifiers.

12. The signal generator as recited in claim 10 wherein the identifier is an index number that corresponds to the current address of the sequence memory.

13. The signal generator as recited in claim 8 wherein signal pattern names are displayed for each of the respective signal patterns and the name of the current output or waiting signal pattern is displayed distinctively from the other signal pattern names using the current address of the sequence memory.

14. The signal generator as recited in claim 8 wherein the current output-or waiting signal pattern is continuously displayed within a display screen even if the current output or waiting signal pattern is changing.
